(19) United States
(12) Patent Application Publication
(10) Pub. No.: US 2021/0150431 A1
(43) Pub. Date: May 20, 2021

(54) COMPUTER ASSET MANAGEMENT

(71) Applicant: Wells Fargo Bank, N.A., San Francisco, CA (US)

(72) Inventors: Jimmie Harold Lenz, Isle of Palms, SC (US); James Frances Horn, III, Alton, IL (US)

(21) Appl. No.: 15/183,262

(22) Filed: Jun. 15, 2016

(51) Int. Cl. G06Q 10/06; G06N 7/00

(52) U.S. Cl. CPC G06Q 10/0635; G06N 7/005; G06Q 10/067

(57) ABSTRACT

Various examples are directed to systems and methods for computer asset management, for example, utilizing one or more computer asset values at risk (VaR). A computer device may determine a first computer asset VaR for a first computer asset at a confidence level. The computer device may utilize the first computer asset VaR, for example, to allocate resources to a failure of the first computer asset. Also, in some examples, the computer device may utilize the first computer asset VaR to allocate one or more hardware assets to the first computer asset.

### TECHNICAL FIELD

Embodiments described herein generally relate to managing and/or optimizing computer assets, such as computer hardware and/or computer software.

### BACKGROUND

A large range of business entities use computing systems, including computer hardware and computer software.

### DRAWINGS

In the drawings, which are not necessarily drawn to scale, like numerals may describe similar components in different views. Like numerals having different letter suffixes may represent different instances of similar components. Some embodiments are illustrated by way of example, and not of limitation, in the figures of the accompanying drawings, in which:

FIG. 1 is a diagram showing an example of an environment for computer asset management.

FIG. 2 is a flow chart showing one example of a process flow that may be executed by the asset management system to manage computer assets considering computer asset value at risk (VaR).

FIG. 3 is a flow chart showing one example of a process flow that may be executed by the asset management system (e.g., the failure data aggregator thereof) to receive and process computer asset failure data.

FIG. 4 is a flow chart showing one example of a process flow that may be executed by the asset risk component to determine a computer asset VaR based on observed computer asset failures.

FIG. 5 is a flow chart showing one example of a process flow that may be executed by the asset risk component to determine a computer asset VaR utilizing a Monte Carlo simulation.

FIG. 6 is a flow chart showing one example of a process flow that may be executed by the asset risk component to determine a computer asset VaR utilizing distribution fitting.

FIG. 7 is a flow chart showing one example of a process flow that may be executed by the asset management system (e.g., resource allocator component thereof) to allocate information technology (IT) resources in the event of a computer asset failure, for example, considering computer asset VaR.

FIG. 8 is a flowchart showing one example of a process flow that may be executed by the resource allocator component to assign or allocate computer hardware to computer assets, such as software assets or data assets.

FIG. 9 is a block diagram showing one example of a software architecture for a computing device.

FIG. 10 is a block diagram illustrating a computing device hardware architecture, within which a set or sequence of instructions can be executed to cause the machine to perform examples of any one of the methodologies discussed herein.

### DETAILED DESCRIPTION

Various examples described herein are directed to systems and methods for managing computer assets. Computer assets may include software assets, such as applications, and/or hardware assets, such as servers, network hardware, data storage hardware, etc. An asset management system may be programmed to manage computer assets in view of the risk of failure posed by the computer assets. The asset management system may be programmed to determine the risk of failure for a computer asset considering both a likely frequency of failure for the asset and likely losses incurred during the failure. For example, failure events may cause losses including costs to rectify the failure by fixing or replacing the computer asset as well as business losses during the failure due to inoperability of the asset. The asset management system, in some examples, may consider the risk posed by computer assets of the computer asset set in terms of a computer asset value at risk (VaR).

A computer asset VaR may describe the maximum loss that the computer asset is likely to cause at a given confidence level and over a given time period. The confidence level is a probability that the computer asset will cause a loss greater than the VaR during the time period. For example, a computer asset VaR over a time period of one month and a confidence level of 95% indicates a 95% chance that the considered computer asset will generate a loss less than the VaR during the relevant month.

The asset management system is programmed to manage the computer assets based at least in part on computer asset VaRs for the respective computer assets. In some examples, the asset management system configures computer assets to minimize or reduce VaR. For example, if a software application has a relatively high VaR, the asset management system may assign and/or reserve back-up hardware capacity to the software application. Also, for example, if a database has a relatively high VaR, the asset management system may establish a backup copy of the database on additional computer hardware. In another example, if a network component, such as a router or switch, has a relatively high VaR, the asset management system may modify a network architecture to establish a redundant network component. Additionally, the asset management system may be programmed to allocate asset recovery resources in the event of failure. For example, if two computer assets fail at the same time, the asset management system may first assign asset recovery resources, such as human technicians, replacement computer assets, diagnostic computer assets, etc. to the higher VaR computer asset.

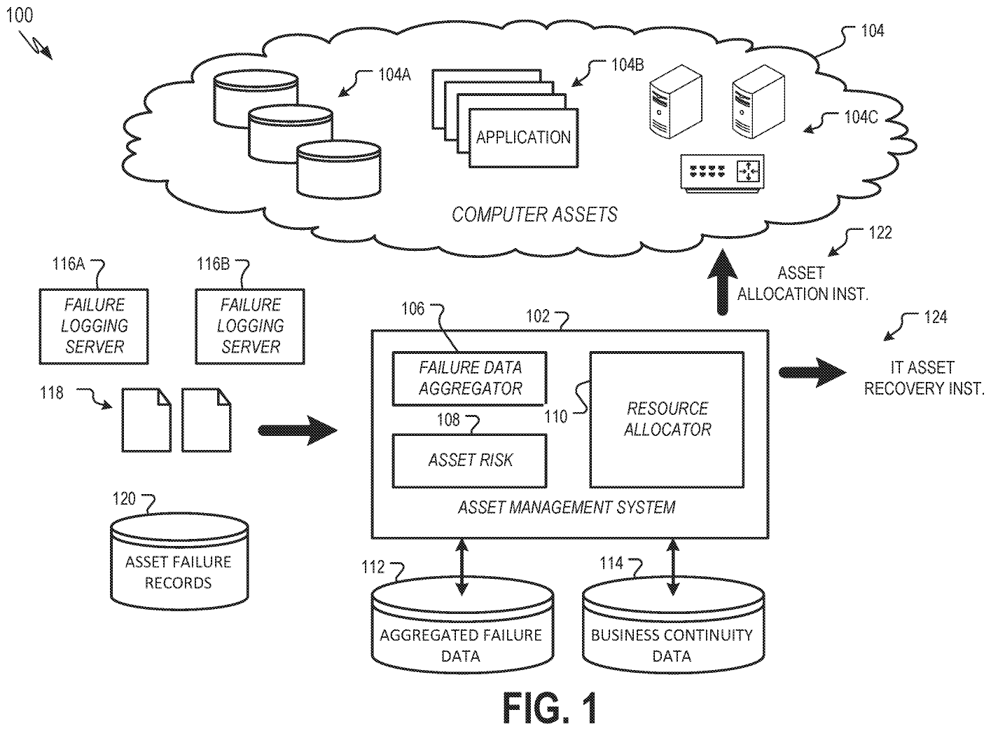

FIG. 1 is a diagram showing an example of an environment 100 for computer asset management. The environment 100 includes an asset management system 102 and computer assets 104 under management. The computer assets 104 may include data assets 104A, software assets 104B, and/or hardware assets 104C. Data assets 104A may include any suitable type of database or other data stores. Examples of data assets 104A may include a Customer Relationship Management (CRM) database, a human resources database including employee information, etc. Other example data assets 104A in the context of a financial institution may include a transaction database storing data describing financial transactions at various stages of execution, an account database describing the balance and/or contents of accounts, etc.

Software assets 104B may include any computer asset that is executable by computer hardware. Example software assets 104B include applications for performing business tasks, such as, for example, document management applications, database management applications, etc. Other software assets 104B that may be executed in the context of a financial institution include back end transaction processing applications, user interface applications for supporting web or mobile access to a financial institution system, etc. Hardware assets 104C may include any suitable computer hardware for executing a software asset 104B and/or hosting a data asset 104A. Example hardware assets 104C include infrastructure hardware such as servers, routers, switches, etc. In some examples, hardware assets 104C also include user computing devices, such as desktop or laptop computers, tablet computers, mobile telephones or other mobile computing devices, etc. Hardware assets 104C, in some examples, may also include data storage devices such as disk drives, memories, etc. A unit of computer hardware may be any division of one or more hardware assets 104C.

The computer assets 104 managed by the asset management system 102 may have any suitable relationship between one another, or no relationship at all. For example, some or all of the set of computer assets 104 may be part of an interconnected computer network. In some examples, however, some or all of the computer assets 104 may be independent of some or all of the other computer assets 104.

The asset management system 102 may comprise various components for managing computing assets including, for example, a failure data aggregator component 106, an asset risk component 108, and a resource allocator component 110. The failure data aggregator component 106 receives failure data describing past failures of computer assets 104 and generates structured failure data, for example, as described herein. The asset risk component 108 may receive the structured failure data and determine a computer asset VaR for some or all of the computer assets 104. The resource allocator component 110 may receive the computer asset VaR or VaRs determined by the asset risk component 108 and may initiate one or more responsive actions.

The failure data aggregator component 106, in some examples, receives failure data generated via one or more failure logging servers 116A, 116B. For example, administrative users or other resources of the computer asset set, may generate failure logs 118 upon the failure of a computer asset. Failure logs 118 may indicate various information about a computer asset failure such as, for example, the computer asset or assets that failed, an impact duration of the failure, a resolution duration of the failure, resources utilized to remedy the failure, etc. The failure data aggregator component 106 may receive failure logs 118 from one or more failure logging servers 116A, 116B and/or from an asset failure records database 120.

The failure data aggregator component 106 may process the failure logs and generate structured failure data describes failure events with respect to one or more of the computer assets. The failure data aggregator component 106 may store structured failure data at a structured failure data store 112. In some examples, the failure data aggregator component 106 may also assign a value to each loss event. Failure event value may be determined, for example, by consulting business continuity data stored at one or more business continuity data stores 114.

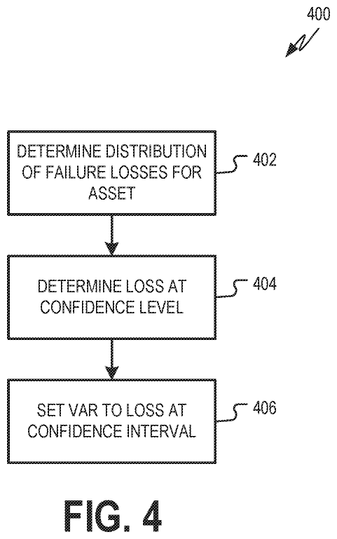

The asset risk component 108 may receive structured failure data generated by the failure data aggregator component 106 and generate VaR values for one or more of the computer assets 104. The asset risk component 108 may determine a computer asset VaR using any suitable methods including, for example, an observation-based method, a Monte Carlo simulation method, and a Pareto distribution method. Additional examples details of how the asset risk component 108 can determine computer asset VaRs are provided herein, for example, with respect to FIGS. 4-6.

The resource allocator may determine and execute responsive actions based on the computer asset VaRs determined by the asset risk component 108. Responsive actions may include, for example, asset allocation instructions 122, and/or asset recovery instruction 124. Asset allocation instructions 122 may be directed to one or more of the computer assets 104. Asset allocation instructions 122 may result in a configuration or reconfiguration of the computer assets 104 to reduce or minimize the VaR. For example, an asset allocation instruction 122 may instruct one or more computer assets (e.g., hardware assets 104C) to make additional (or less) server capacity available for a particular software asset 104B. In another example, an asset allocation instruction 122 may allocate more or less CPU, RAM, and/or disk space to a particular software asset. In another example, an asset allocation instruction 122 may instruct a server to execute (and/or cease executing) a second hypervisor and/or virtual machine for a software asset. For example, a hypervisor and/or virtual machine could be executed at multiple servers (e.g., at the same server farm and/or other arrangement of computing devices). If a machine executing the primary version of the hypervisor or virtual machine goes down, the secondary version could be queued to start up and/or already executing to take over the load of the primary. Also, in some examples, hardware computing resources may have different capabilities by virtue of computing equipment itself and/or the facility. For example, if a first facility housing computing devices has better security, better power redundancy, better fire suppression, etc., than a second facility, an asset allocation instruction 122 may direct that higher VaR software computing resource be executed at the first facility while a lower VaR software computing resource is executed at the second facility.

Asset recovery instructions may allocate recovery resources, such as human technicians, recovery hardware, etc., to one or more computer asset failures based, at least in part on the VaR or VaRs of the failed assets. For example, if multiple asset failures occur at the same time, the resource allocator component 110 may triage the failed assets and recovery resources based on the computer asset VaRs of the respective resources. Asset recovery instructions 124 may implement the resource assignments.

The asset management system 102 may comprise one or more computing devices, such as servers, configured to operate as described herein. Computing devices making up the asset management system 102 may be located at a single geographic location and/or may be distributed across multiple geographic locations. In some examples, the asset management system 102 may be implemented in a “cloud computing” environment or as a “software as a service” (SaaS). For example, at least some of the operations of the asset management system 102 may be performed by a group of computing devices, with these operations being accessible via a network and/or via one or more appropriate interfaces (e.g., an Application Program Interface (API)). The components 106, 108, 110 may be implemented in any suitable hardware, software, or mix of hardware and software.

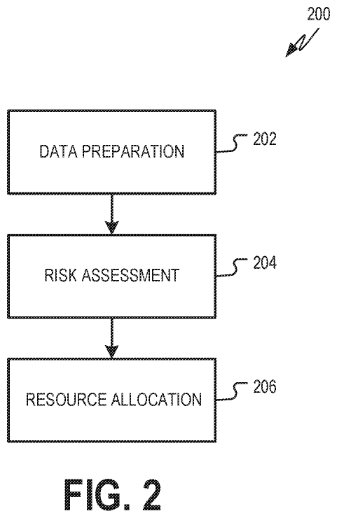

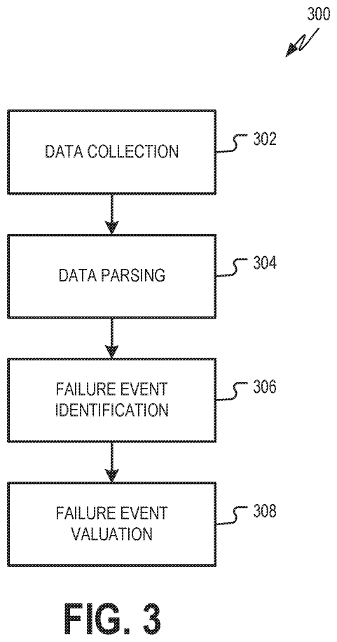

FIG. 2 is a flow chart showing one example of a process flow 200 that may be executed by the asset management system to manage computer assets considering computer asset VaR. At action 202, the asset management system 102 (e.g., the failure data aggregator component 106) may receive and prepare failure data for analysis. For example, the failure data aggregator component 106 may parse unstructured failure data to identify computer asset failure events. In some examples, the failure data aggregator component 106 may also assign a value to failure events. The failure data aggregator component 106 may generate structured failure data, which may be stored at the structured failure data store 112 described above. Additional details of the data preparation that may be performed by the failure data aggregator component 106 are described herein with respect to FIG. 3.

At action 204, asset management system 102 (e.g., the asset risk component 108) may perform a risk assessment for one or more of the computer assets 104. For example, the asset risk component 108 may perform the risk assessment considering the structured failure data generated by the failure data aggregator component 106. In some examples, the risk assessment performed by the asset risk component 108 is a computer asset VaR as described herein. The asset risk component 108 may perform a risk assessment for one computer asset 104 and/or a number of computer assets 104. Additional details describing how the asset risk component 108 may perform risk assessments for computer assets are provided herein, for example, with respect to FIGS. 4-6.

At action 206, the asset management system (e.g., the resource allocator component 110) may allocate computer assets and/or resources based at least in part on the risk assessment of action 204. For example, the resource allocator component 110 may generate and/or send one or more asset allocation instructions 122 to one or more computer assets 104, generate and/or send one or more asset recovery instructions 124, etc.

FIG. 3 is a flow chart showing one example of a process flow 300 that may be executed by the asset management system 102 (e.g., the failure data aggregator component 106 thereof) to receive and process computer asset failure data (e.g., failure data). For example, the process flow 300 shows one example implementation of action 202 from the process flow 200.

At action 302, the failure data aggregator component 106 may perform data collection. Data collection may include gathering failure data for one or more of the computer assets 104. Failure data may describe one or more historic failures of the computer assets 104. Failure data may be received in any suitable format from any suitable source. In some examples, failure data includes failure logs 118 received from one or more failure logging servers 116A, 116B. Failure logging servers 116A, 116B may receive failure logs 118 from one or more administrative users, logging applications, or from any other suitable source. For example, an administrative user may monitor the operation of one or more computer assets 104 and/or may receive alerts originating from other users of the computer assets 104 when an asset experiences a failure. The administrative user may provide a failure logging server 116A, 116B with a failure log 118 describing the asset failure. A failure log 118 for an asset failure may include, for example, a description of the computer asset 104, a description of the type of failure, a duration of the failure, and any other suitable relevant information.

Failure logs 118 received by the failure logging servers 116A, 116B, in some examples, are formatted as unstructured text. For example, a failure logging server 116A, 116B may provide an administrative user with an interface for providing freeform text describing the failure. In other examples, the failure logging servers 116A, 116B may be configured to receive structured text describing a computer asset failure, for example, by providing an interface including drop-down menus, check boxes or other suitable mechanisms for receiving structured text.

At action 304, the failure data aggregator component 106 may parse failure data received at 302. As described above, in some examples, failure data, such as failure logs 118, may be received in an unstructured text format. Parsing the failure data may include processing the failure data to convert it to a structured format suitable for further processing. In some examples, the failure data aggregator component 106 may remove punctuation from received failure data. The failure data aggregator component 106 may subsequently identify n-grams within the failure data, where n-grams are recurring patterns of text strings in the failure data. N-grams may be of any suitable length. For example, 2-grams may include two words or other text strings; 3-grams may include three words or other text strings, etc. N-grams may be used to construct context vectors describing words or other similar strings that occur together. The use of n-grams and context vectors may make the data parsing better able to detect misspellings and other errors in data entry that may be made by the administrative users when creating failure logs 118 and other failure data.

At action 306, the failure data aggregator component 106 may identify computer asset failures from the failure data parsed at action 304. For example, the failure data aggregator component 106 may extract from the failure data references to specific failures of computer assets 104 and de-duplicate multiple references to the same failure. Parsing may also include extracting from the failure data descriptions of the computer asset 104 involved in a failure, descriptions of the type of failure, descriptions of the duration of the failure, and any other suitable relevant information. When the failure data is parsed to n-grams and context vectors, as described herein, extracting specific failures may include identifying context vectors that refer to specific failures or failures of a specific type and then identifying instances of those context vectors in close proximity to the names or other identifiers of computer assets.

Identifying a computer asset failure may include identifying various data describing a computer asset failure such as, a name of the computer asset, a type of the computer asset, a business team or area served by computer asset, the information technology (IT) resource that responded to a failure, a severity of the failure. In some examples, identifying a computer asset failure may include identifying various timing data describing the failure. Examples of timing data describing a computer asset failure may include a failure start time, a failure end time, a ticket open time (indicating when an information technology (IT) resource is notified of the failure), a ticket close time (indicating when the IT resource has completed the rectification of the failure), an impact end time (indicating when the computer asset is brought back online), a total recovery time (indicating when the IT resource has finished re-entering lost or missed data), etc.

At action 308, the failure data aggregator component 106 may value failure events identified at action 306. For example, the value of a failure event may be included in structured failure data (e.g., stored at structured failure data store 112 for use by the failure data aggregator component 106 as described herein). Failure events may be valued in any suitable manner. Factors that may be considered to determine the value of a computer asset failure event may include, for example, the disruption to the business of the entity implementing the computer asset, the cost of resources expended to correct the failure (e.g., people and other computer assets), a reputational cost to the entity implementing the computer asset (e.g., if the failure becomes known to the public), etc.

The failure data aggregator component 106 may consider the cost of the business disruption from a computer asset failure in any suitable manner, and may depend on the type of business pursued by the entity implementing the computer asset. When the entity implementing the computer asset is involved in direct customer interaction, the cost of a business disruption may include the cost of lost customer interactions. For example, if the entity is involved in sales or technical service, and the computer asset failure prevents customer calls from being answered or returned in a timely manner, the failure data aggregator component 106 may be programmed to estimate a cost of each missed call. When the entity is involved in manufacturing, and the computer asset failure causes a production line to go down, the failure data aggregator component 106 may estimate the value of each unit of lost production time, overtime necessary to overcome lost production time, etc.

In some lines of business, such as in the financial services industry, entities may be required by regulation to maintain business continuity plans that describe a best estimate of the financial loss associated with a failure of a computer asset 104. When such business continuity data exists, the failure data aggregator component 106 may consult business continuity data to determine the value associated with a computer asset failure. In many examples, the value of a computer asset failure will be negative (e.g., the entity implementing computer asset will suffer a loss because of the failure), although it is conceivable that in some instances a computer asset failure will be positive. The failure data aggregator component 106 may incorporate identified computer asset failures, data describing the failures, and data describing the failures, into structured failure data, which may be stored at the structured failure data store 112 described herein.

To further illustrate actions 306 and 308, consider an example of a computer asset that is a trading application implemented by a financial institution business entity to process securities trade orders. If the trading application fails, securities trade orders may not be processed. The failure data aggregator component 106 may identify within failure data one or more context vectors referencing a name, or permutations of the name, of the trading application. The failure data aggregator component 106 may examine n-grams around the references to the application name. These n-grams may include text strings referencing, for example, one or more trading desks or other business units that relied on the trading application to process trades, an IT resource that responded to the failure, an impact time of the failure (e.g., the time that the trading application was down), a number of trades impacted by the failure, a total recovery time for the failure, etc.

The failure data aggregator component 106 may value the failure by referring to a business continuity plan for the implementing financial institution, which may specify an estimated loss for downtime of the trading application, for example, by impact time, number of impacted trades, or any other suitable metric. The failure data aggregator component 106 may also consider the cost of the IT resources necessary to bring the trading application back online. Also, in some examples, the failure data aggregator component 106 may also consider a difference in market price between the securities involved in the trade at the time that the trade was executed and at the later time that the trade was consummated (e.g., when the trading application came online).

Referring again to FIG. 2, the asset risk component 108 may utilize structured failure data generated by the failure data aggregator component 106 to generate a risk assessment for one or more of the computer assets 104. As described, the risk assessment may include a computer asset VaR. Computer asset VaR may be generally given by Equation [1] below:

P{δπ≤VaR}=(1−c) [1]

In Equation [1], VaR is the computer asset VaR; δπ is the loss due to failure of the computer asset over a given time period; and c is the confidence level. As described above, the loss due to failure is, in many but not all cases, negative. The left side of Equation [1] indicates the probability that the loss due to failure of the computer asset over the given time period is less than the VaR. The right side of the Equation [1] indicates one minus the confidence level. Returning to the example above, if the confidence level is 95% and the time period is one month, then there may be a 95% probability that the loss due to failure of the computer asset in any given month will be less than the VaR.

Computer asset VaR may be found from structured failure data in any suitable manner. For example, FIGS. 4-6 show process flows that may be executed by the asset risk component 108 to generate a computer asset VaR risk assessment according to different example methods. The process flows shown in FIGS. 4-6 illustrate a risk assessment for a single computer asset. In some examples, the asset risk component 108 may be programmed to repeat one or a combination of the process flows of FIGS. 4-6 for multiple computer assets 104 and, in some examples, for all computer assets described by structured failure data store 112.

FIG. 4 is a flow chart showing one example of a process flow 400 that may be executed by the asset risk component 108 to determine a computer asset VaR based on observed computer asset failures. At action 402, the asset risk component 108 may determine a distribution of failure losses for the computer asset by the time period. For example, the distribution may include a number of time periods (e.g., days, months, etc.) during which the computer asset was observed. If no failure of the computer asset occurs in a given time period, then the loss for that time period may be zero. If one or more failures of the computer asset occur in a time period, the loss for that time period (e.g., a time period loss) may be the sum of losses from failures that occurred during the time period. Generating the distribution of failure event values may include generating a ranking or listing of time periods ordered by the magnitude of loss due to computer asset failure during each time period. Generating the distribution may include affirmatively ordering a list of the time periods in a memory of the asset risk component 108 and/or the asset management system 102 and/or simply deriving and storing a value-based order of the time periods. In some examples, action 402 may be omitted and action 404 below may be executed on an unordered list of time periods.

At action 404, the asset risk component 108 may determine the loss at the confidence level of the distribution from action 402. For example, the asset risk component 108 may identify a loss at which c % of the time periods in the distribution had equal or lesser losses, where c is the confidence level. At action 406, the asset risk component 108 may set the VaR for the computer asset to the level of loss at the confidence level. The process flow 400 may provide a good estimation of computer asset VaR, for example, in relation to computer assets that have been observed over a relatively large number of time periods and/or a relatively large number of observed failures.

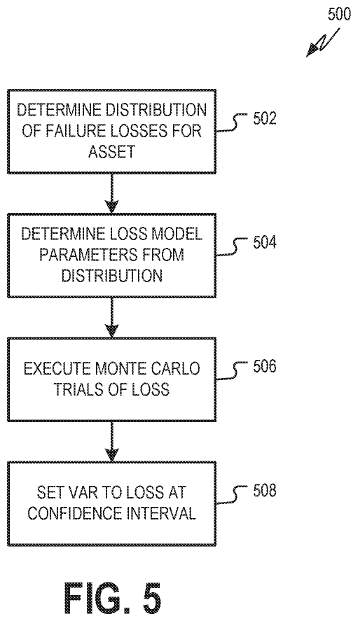

FIG. 5 is a flow chart showing one example of a process flow 500 that may be executed by the asset risk component 108 to determine a computer asset VaR utilizing a random simulation, such as any suitable Monte Carlo method or methods. At action 502, the asset risk component 108 may determine a distribution of failure losses for the computer asset by time period, similar to what is described above with respect to the action 402. At action 504, the asset risk component 108 may determine loss model parameters from the distribution. The loss model parameters may describe a model that will be used to estimate losses for the computer asset over a plurality of modeled instances of the time period. For example, loss model parameters may be used to determine a range of VaR values for the considered computer asset. The VaR for any given trial may be randomly selected to fall in the determined range.

At action 506, the asset risk component 108 may execute random or trials of the model (which may be referred to as Monte Carlo trials in some examples). Each trial of the model may represent a trial time period of the computer asset. For example, the result of each trial may be a trial time period loss incurred by the computer asset over the trial time period. To run a trial, the asset risk component 108 may select a random or pseudorandom number. The asset risk component 108 may apply the model parameters to the random or pseudorandom number to determine the trial time period loss for the trial time period. Any suitable number of trials may be executed. Upon completion, the asset risk component 108 may store a trial time period loss for each executed trial. At action 508, the asset risk component 108 may set the VaR for the computer asset to the loss at the confidence level. For example, the VaR may be set such that c % of the trials returned losses equal to or greater than the selected VaR.

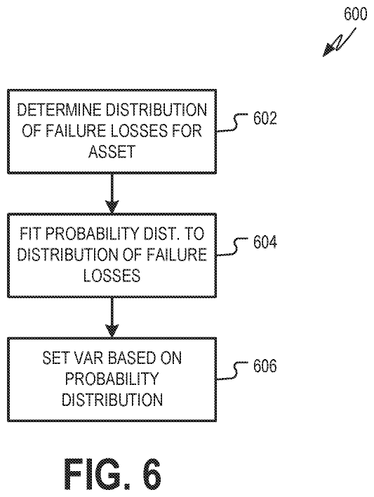

FIG. 6 is a flow chart showing one example of a process flow 600 that may be executed by the asset risk component to determine a computer asset VaR utilizing a probability distribution fitting. At action 602, the asset risk component 108 may determine a distribution of failure losses for the computer asset by the time period, for example, similar to the action 402 described above. At action 604, the asset risk component 108 may fit a probability distribution to the distribution of losses from action 602. Any suitable probability distribution may be used, including, for example, a normal distribution, and a Pareto distribution. At action 606, the asset risk component 108 may set the VaR based on the probability distribution. For example, different probability distributions may provide different values for VaR. In examples where the probability distribution is a normal distribution, the computer asset VaR may be found by applying an inverse cumulative distribution function with the confidence level to find a multiplier. The multiplier may be applied to the standard deviation of the normal distribution to find an offset. The offset may then be subtracted from the mean of the normal distribution to determine the computer asset VaR.

In examples where the probability distribution is a Pareto distribution, any suitable technique may be used to find the computer asset VaR. For example, the asset risk component 108 may fit a composite lognormal/generalized Pareto distribution to distribution of losses from action 602, for example, as given by Equation [2] below:

$$F ( x ) = 1 - ( 1 - F ( u ) ) {( 1 + ξ \frac{x - u}{σ ( u )} )}^{- \frac{1}{ξ}} \qquad [ 2 ]$$

In Equation [2], u is a threshold between the portion of the distribution modeled by a lognormal distribution and a portion of the distribution modeled with a Pareto distribution. The value σ is the scale parameter of the Pareto distribution and the value ξ is a shape parameter for the Pareto distribution. Utilizing Equation [2], the computer asset VaR may be found according to Equation [3] below:

$$VaR ( q ) = u + \frac{σ}{ξ} ( {( \frac{n}{{N}_{u}} ( 1 - q ) )}^{- ξ} - 1 ) \qquad [ 3 ]$$

In Equation [3], q is the confidence interval, The value n is the number of observations in the distribution of losses and the number Nu is the number of observations exceeding the threshold u. Equations [2] and [3] provide just one example for determining computer asset VaR utilizing a Pareto distribution. Other mathematical methods could be used as well.

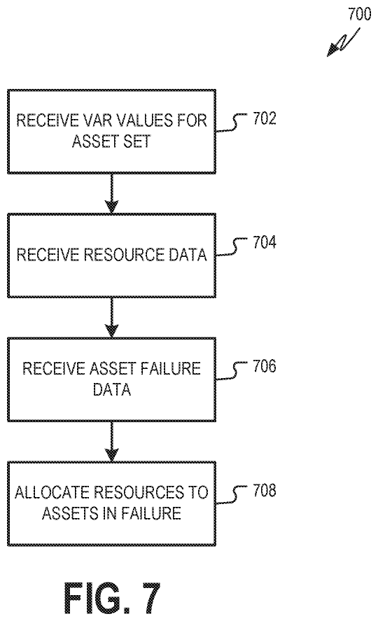

FIG. 7 is a flow chart showing one example of a process flow 700 that may be executed by the asset management system 102 (e.g., resource allocator component 110 thereof) to allocate information technology (IT) resources in the event of a computer asset failure, for example, considering computer asset VaR. At action 702, the resource allocator component 110 may receive VaR values for an asset set. The VaR values, for example, may be determined by the asset risk component 108, for example, as described herein. In some examples, the VaR values for the set of computer assets may have been determined for a common time period (e.g., one day, one week, one month, etc.). The VaR values for the set of computer assets may be been determined with a common method (e.g., one of the process flows 400, 500, 600) or may have been determined according to different methods, for example, based on the failure data available for the computer assets.

At action 704, the resource allocator component 110 may receive IT resource data. IT resource data may describe IT resources that are available for deployment. IT resources may include human users or any type of computing hardware and/or software. At action 706, the resource allocator component 110 may receive current asset failure data. The asset failure data received at action 706 may describe at least one computer asset failure event that is currently occurring. At action 708, the resource allocator component 110 may allocate the IT resources to the computer assets in failure based at least in part on the VaRs for the computer assets, for example, by sending an asset recovery instruction 124 to an IT resource. For example, if two computer assets are in failure, the resource allocator component 110 may assign IT resources to the computer asset with the higher VaR first. If any IT resources remain, they may be assigned to the lower VaR computer asset. Also, in some examples, if a single asset is in failure, but other, higher-VaR computing assets are also present, the resource allocator component 110 may reserve or hold back at least a portion of the IT resources in case a higher-VaR computing asset fails. For example, if the resource allocator component 110 receives data indicating that one or more higher VaR computer resources are in the set of managed computer resources, it may be programmed to allocate less than all of the available IT resources to computer assets currently in failure. In another example, the resource allocator component 110 may assign a higher capacity network connection to a computing device executing a software computer asset in failure, for example, by changing a router, etc.

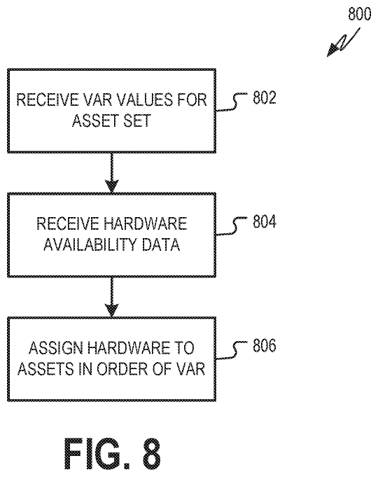

FIG. 8 is a flow chart showing one example of a process flow 800 that may be executed by the resource allocator component 110 to assign or allocate computer hardware to computer assets, such as software assets 104B or data assets 104A. At action 802, the resource allocator component 110 may receive VaR values for a set of computer assets 104. At action 804, the resource allocator component 110 may receive computer hardware available data. The computer hardware availability data may describe, for example, computer hardware assets 104C that are available to execute software assets 104B and/or store data assets 104A. At action 806, the resource allocator component 110 may assign hardware assets 104C to software assets 104B and/or data assets 104A, for example, based on the VaR of the respective software assets 104B and/or data assets 104A. For example, the resource allocator component 110 may assign hardware assets 104C to software assets 104B or data asset 104A in order of VaR. Software assets 104B or data assets 104A with higher VaR may be assigned additional hardware to minimize the risk of failure.

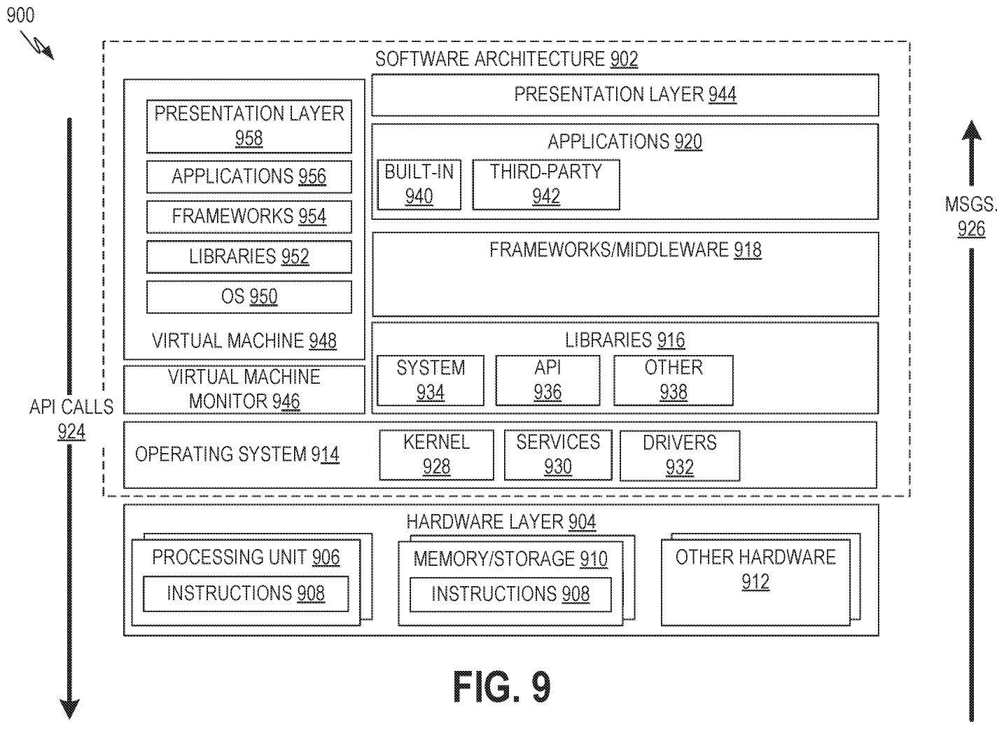

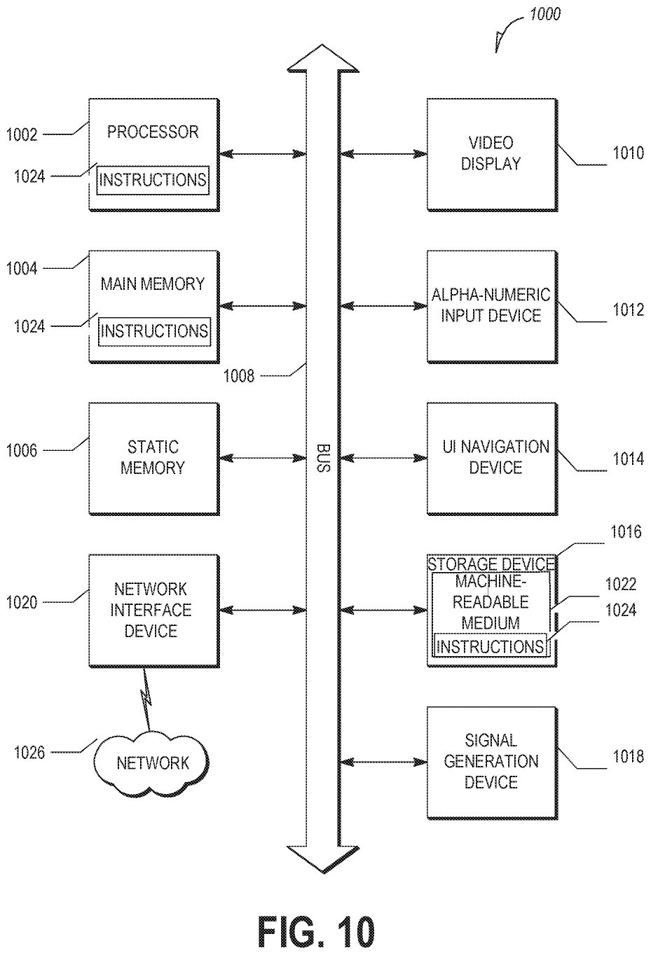

FIG. 9 is a block diagram 900 showing one example of a software architecture 902 for a computing device. The software architecture 902 may be used in conjunction with various hardware architectures, for example, as described herein. FIG. 9 is merely a non-limiting example of a software architecture and many other architectures may be implemented to facilitate the functionality described herein. The software architecture 902 may be executed on hardware such as, for example, the asset management system 102, failure data aggregator component 106, asset risk component 108, resource allocator component 110, hardware computer assets 104C, etc. A representative hardware layer 904 is illustrated and can represent, for example, any of the above referenced computing devices. In some examples, the hardware layer 904 may be implemented according to the architecture 1000 of FIG. 10.

The representative hardware layer 904 comprises one or more processing units 906 having associated executable instructions 908. Executable instructions 908 represent the executable instructions of the software architecture 902, including implementation of the methods, modules, components, and so forth of FIGS. 2-8. Hardware layer 904 also includes memory and/or storage modules 910, which also have executable instructions 908. Hardware layer 904 may also comprise other hardware as indicated by other hardware 912, which represents any other hardware of the hardware layer 904, such as the other hardware illustrated as part of hardware architecture 1000.

In the example architecture of FIG. 9, the software architecture 902 may be conceptualized as a stack of layers where each layer provides particular functionality. For example, the software architecture 902 may include layers such as an operating system 914, libraries 916, frameworks/middleware 918, applications 920 and presentation layer 958. Operationally, the applications 920 and/or other components within the layers may invoke application programming interface (API) calls 924 through the software stack and receive a response, returned values, and so forth illustrated as messages 926 in response to the API calls 924. The layers illustrated are representative in nature and not all software architectures have all layers. For example, some mobile or special purpose operating systems may not provide a frameworks/middleware layer 918, while others may provide such a layer. Other software architectures may include additional or different layers.

The operating system 914 may manage hardware resources and provide common services. The operating system 914 may include, for example, a kernel 928, services 930, and drivers 932. The kernel 928 may act as an abstraction layer between the hardware and the other software layers. For example, the kernel 928 may be responsible for memory management, processor management (e.g., scheduling), component management, networking, security settings, and so on. The services 930 may provide other common services for the other software layers. The drivers 932 may be responsible for controlling or interfacing with the underlying hardware. For instance, the drivers 932 may include display drivers, camera drivers, Bluetooth® drivers, flash memory drivers, serial communication drivers (e.g., Universal Serial Bus (USB) drivers), Wi-Fi® drivers, NFC drivers, audio drivers, power management drivers, and so forth depending on the hardware configuration.

The libraries 916 may provide a common infrastructure that may be utilized by the applications 920 and/or other components and/or layers. The libraries 916 typically provide functionality that allows other software modules to perform tasks in an easier fashion than to interface directly with the underlying operating system 914 functionality (e.g., kernel 928, services 930 and/or drivers 932). The libraries 916 may include system 934 libraries (e.g., C standard library) that may provide functions such as memory allocation functions, string manipulation functions, mathematic functions, and the like. In addition, the libraries 916 may include API libraries 936 such as media libraries (e.g., libraries to support presentation and manipulation of various media format such as MPEG4, H.264, MP3, AAC, AMR, JPG, PNG), graphics libraries (e.g., an OpenGL framework that may be used to render 2D and 9D in a graphic content on a display), database libraries (e.g., SQLite that may provide various relational database functions), web libraries (e.g., WebKit that may provide web browsing functionality), and the like. The libraries 916 may also include a wide variety of other libraries 938 to provide many other APIs to the applications 920 and other software components/modules.

The frameworks 918 (also sometimes referred to as middleware) may provide a higher-level common infrastructure that may be utilized by the applications 920 and/or other software components/modules. For example, the frameworks 918 may provide various graphic user interface (GUI) functions, high-level resource management, high-level location services, and so forth. The frameworks 918 may provide a broad spectrum of other APIs that may be utilized by the applications 920 and/or other software components/modules, some of which may be specific to a particular operating system or platform.

The applications 920 includes built-in applications 940 and/or third party applications 942. Examples of representative built-in applications 940 may include, but are not limited to, a contacts application, a browser application, a book reader application, a location application, a media application, a messaging application, and/or a game application. Third party applications 942 may include any of the built in applications as well as a broad assortment of other applications. In a specific example, the third party application 942 (e.g., an application developed using the Android™ or iOS™ software development kit (SDK) by an entity other than the vendor of the particular platform) may be mobile software running on a mobile operating system such as iOS™, Android™, Windows® Phone, or other mobile computing device operating systems. In this example, the third party application 942 may invoke the API calls 924 provided by the mobile operating system such as operating system 914 to facilitate functionality described herein.

The applications 920 may utilize built in operating system functions (e.g., kernel 928, services 930 and/or drivers 932), libraries (e.g., system 934, APIs 936, and other libraries 938), frameworks/middleware 918 to create user interfaces to interact with users of the system. Alternatively, or additionally, in some systems interactions with a user may occur through a presentation layer, such as presentation layer 944. In these systems, the application/module “logic” can be separated from the aspects of the application/module that interact with a user.

Some software architectures utilize virtual machines. In the example of FIG. 9, this is illustrated by virtual machine 948. A virtual machine creates a software environment where applications/modules can execute as if they were executing on a hardware computing device. A virtual machine is hosted by a host operating system (operating system 914) and typically, although not always, has a virtual machine monitor 946, which manages the operation of the virtual machine as well as the interface with the host operating system (i.e., operating system 914). A software architecture executes within the virtual machine such as an operating system 950, libraries 952, frameworks/middleware 954, applications 956 and/or presentation layer 958. These layers of software architecture executing within the virtual machine 948 can be the same as corresponding layers previously described or may be different.

FIG. 10 is a block diagram illustrating a computing device hardware architecture 1000, within which a set or sequence of instructions can be executed to cause the machine to perform examples of any one of the methodologies discussed herein. For example, the architecture 1000 may execute the software architecture 902 described with respect to FIG. 9. The architecture 1000 may operate as a standalone device or may be connected (e.g., networked) to other machines. In a networked deployment, the architecture 1000 may operate in the capacity of either a server or a client machine in server-client network environments, or it may act as a peer machine in peer-to-peer (or distributed) network environments. The architecture 1000 can be implemented in a personal computer (PC), a tablet PC, a hybrid tablet, a set-top box (STB), a personal digital assistant (PDA), a mobile telephone, a web appliance, a network router, switch or bridge, or any machine capable of executing instructions (sequential or otherwise) that specify actions to be taken by that machine.

Example architecture 1000 includes a processor unit 1002 comprising at least one processor (e.g., a central processing unit (CPU), a graphics processing unit (GPU) or both, processor cores, compute nodes, etc.). The architecture 1000 may further comprise a main memory 1004 and a static memory 1006, which communicate with each other via a link 1008 (e.g., bus). The architecture 1000 can further include a video display unit 1010, an alphanumeric input device 1012 (e.g., a keyboard), and a user interface (UI) navigation device 1014 (e.g., a mouse). In some examples, the video display unit 1010, input device 1012 and UI navigation device 1014 are incorporated into a touch screen display. The architecture 1000 may additionally include a storage device 1016 (e.g., a drive unit), a signal generation device 1018 (e.g., a speaker), a network interface device 1020, and one or more sensors (not shown), such as a global positioning system (GPS) sensor, compass, accelerometer, or other sensor.

The storage device 1016 includes a machine-readable medium 1022 on which is stored one or more sets of data structures and instructions 1024 (e.g., software) embodying or utilized by any one or more of the methodologies or functions described herein. The instructions 1024 can also reside, completely or at least partially, within the main memory 1004, static memory 1006, and/or within the processor 1002 during execution thereof by the architecture 1000, with the main memory 1004, static memory 1006, and the processor 1002 also constituting machine-readable media. Instructions stored at the machine-readable medium 1022 may include, for example, instructions for implementing the software architecture 902, instructions for executing any of the features described herein, etc.

While the machine-readable medium 1022 is illustrated in an example to be a single medium, the term “machine-readable medium” can include a single medium or multiple media (e.g., a centralized or distributed database, and/or associated caches and servers) that store the one or more instructions 1024. The term “machine-readable medium” shall also be taken to include any tangible medium that is capable of storing, encoding or carrying instructions for execution by the machine and that cause the machine to perform any one or more of the methodologies of the present disclosure or that is capable of storing, encoding or carrying data structures utilized by or associated with such instructions. The term “machine-readable medium” shall accordingly be taken to include, but not be limited to, solid-state memories, and optical and magnetic media. Specific examples of machine-readable media include non-volatile memory, including, but not limited to, by way of example, semiconductor memory devices (e.g., electrically programmable read-only memory (EPROM), electrically erasable programmable read-only memory (EEPROM)) and flash memory devices; magnetic disks such as internal hard disks and removable disks; magneto-optical disks; and CD-ROM and DVD-ROM disks.

The instructions 1024 can further be transmitted or received over a communications network 1026 using a transmission medium via the network interface device 1020 utilizing any one of a number of well-known transfer protocols (e.g., HTTP). Examples of communication networks include a local area network (LAN), a wide area network (WAN), the Internet, mobile telephone networks, plain old telephone (POTS) networks, and wireless data networks (e.g., Wi-Fi, 3G, and 6G LTE/LTE-A or WiMAX networks). The term “transmission medium” shall be taken to include any intangible medium that is capable of storing, encoding, or carrying instructions for execution by the machine, and includes digital or analog communications signals or other intangible medium to facilitate communication of such software.

Various components are described in the present disclosure as being configured in a particular way. A component may be configured in any suitable manner. For example, a component that is or that includes a computing device may be configured with suitable software instructions that program the computing device. A component may also be configured by virtue of its hardware arrangement or in any other suitable manner.

The above description is intended to be illustrative, and not restrictive. For example, the above-described examples (or one or more aspects thereof) can be used in combination with others. Other embodiments can be used, such as by one of ordinary skill in the art upon reviewing the above description. The Abstract is to allow the reader to quickly ascertain the nature of the technical disclosure, for example, to comply with 37 C.F.R. § 1.72(b) in the United States of America. It is submitted with the understanding that it will not be used to interpret or limit the scope or meaning of the claims.

Receiving data, as described herein, may involve data being transferred to the receiving computing device or component, which may store the received data in a memory. When the receiving computing device or component processes the received data, it may identify the data in the memory and/or retrieve the data for processing.

Also, in the above Detailed Description, various features can be grouped together to streamline the disclosure. However, the claims cannot set forth every feature disclosed herein as embodiments can feature a subset of said features. Further, embodiments can include fewer features than those disclosed in a particular example. Thus, the following claims are hereby incorporated into the Detailed Description, with a claim standing on its own as a separate embodiment. The scope of the embodiments disclosed herein is to be determined with reference to the appended claims, along with the full scope of equivalents to which such claims are entitled.

1. A system for managing computer assets, the system comprising at least one processor and a memory in communication with the at least one processor, wherein the system is programmed to:
select failure data describing a first computer asset over a plurality of time periods comprising a first time period and a second time period;
identify, from the failure data, first failure data describing a first failure of the first computer asset occurring during a first time period of the plurality of time periods;
determine a first time period loss describing losses due to failure of the first computer asset during the first time period, the first time period loss based at least in part on the first failure data;
determine a second time period loss describing losses due to failure of the first computer asset during the second time period, wherein the second time period loss is zero;
determine a first computer asset value at risk (VaR) for the first computer asset at a confidence level, wherein determining the first computer asset VaR comprises determining a first loss level at which a confidence level percentage of the plurality of time periods had time period losses equal to or less than the first loss level, wherein the first loss level is the first computer asset VaR;
receive first current asset failure data indicating a current failure at the first computer asset;
receive second current asset failure data indicating a current failure at a second computer asset;
receive resource data describing at least one resource for correcting computer asset failures;
determine that the first computer asset VaR for the first computer asset is greater than a second computer asset VaR for the second computer asset; and
responsive to the determining that the first computer asset VaR for the first computer asset is greater than the second computer asset VaR for the second computer asset, send an allocation instruction indicating that the at least one resource is to be assigned to the first computer asset to correct the current failure at the first computer asset by repairing the first computer asset.

2. The system of claim 1, wherein the system is further programmed to:
receive a plurality of failure logs including data describing a plurality of failure events of the first computer asset; and
parse the plurality of failure logs to generate the failure data.

3. The system of claim 1, further comprising determining a loss from the first failure of the first computer asset at least in part by receiving resource data describing at least one resource used to correct the first failure of the first computer asset.

4. The system of claim 1, wherein determining the first computer asset VaR for the first computer asset at the confidence level comprises: from a plurality of time period losses including the first time period loss and the second time period loss, selecting the first computer asset VaR such that the confidence level of the plurality of time period losses are less than or equal to the first computer asset VaR.

5. The system of claim 1, wherein determining the first computer asset VaR for the first computer asset at the confidence level comprises:
determine a first model parameter based at least in part on the first time period loss and the second time period loss;
execute a plurality of random trials based at least in part on the first model parameter, wherein a first trial of the plurality of random trials results in a first trial time period loss and a second trial of the plurality of random trials results in a second trial time period loss; and
from a plurality of trial time period losses including the first trial time period loss and the second trial time period loss, selecting the first computer asset VaR such that the confidence level of the plurality of trial time period losses are less than or equal to the first computer asset VaR.

6. The system of claim 1, wherein determining the first computer asset VaR for the first computer asset at the confidence level comprises:
fitting a probability distribution to a plurality of time period losses from the first computer asset, the plurality of time period losses comprising the first time period loss and the second time period loss; and
selecting the first computer asset VaR based at least in part on the probability distribution.

7. The system of claim 6, wherein the probability distribution is a Pareto distribution.

8. The system of claim 1, wherein the system is further programmed to:
receive third computer asset VaR data indicating a third computer asset VaR;
determine that the third computer asset VaR is greater than the first computer asset VaR and the second computer asset VaR; and
reserve at least a portion of the at least one resource.

9. A method for managing computer assets, comprising:
selecting, by a computer device, failure data describing a first computer asset over a plurality of time periods comprising a first time period and a second time period;
identifying, by the computer device and from the failure data, first failure data describing a first failure of the first computer asset occurring during a first time period of the plurality of time periods;
determining, by the computer device, a first time period loss describing losses due to failure of the first computer asset during the first time period, the first time period loss based at least in part on the first failure data;
determining, by the computer device, a second time period loss describing losses due to failure of the first computer asset during the second time period, wherein the second time period loss is zero;
determining, by the computer device, a first computer asset value at risk (VaR) for the first computer asset at a confidence level, wherein determining the first computer asset VaR comprises determining a first loss level at which a confidence level percentage of the plurality of time periods had time period losses equal to or less than the first loss level, wherein the first loss level is the first computer asset VaR;
receiving, by the computer device, first current asset failure data indicating a current failure at the first computer asset;
receiving, by the computer device, second current asset failure data indicating a current failure at a second computer asset;
receiving, by the computer device, resource data describing at least one resource for correcting computer asset failures;
determining, by the computer device, that the first computer asset VaR for the first computer asset is greater than a second computer asset VaR for the second computer asset; and
responsive to the determining that the first computer asset VaR for the first computer asset is greater than the second computer asset VaR for the second computer asset, sending, by the computer device, an allocation instruction indicating that the at least one resource is to be assigned to the first computer asset to correct the current failure at the first computer asset by repairing the first computer asset.

10. A system for managing computer assets, the system comprising at least one processor and a memory in communication with the at least one processor, wherein the system is programmed to:
select failure data describing a plurality of failure events of a first computer asset over a plurality of time periods comprising a first time period and a second time period;
identify, from the failure data, first failure data describing a first failure of the first computer asset occurring during a first time period of the plurality of time periods;
determine a first time period loss describing losses due to failure of the first computer asset during the first time period, the first time period loss based at least in part on the first failure data;
determine a second time period loss describing losses due to failure of the first computer asset during the second time period, wherein the second time period loss is zero;
determine a value at risk (VaR) for the first computer asset at a confidence level, wherein determining the first computer asset VaR comprises determining a first loss level at which a confidence level percentage of the plurality of time periods had time period losses equal to or less than the first loss level, wherein the first loss level is the first computer asset VaR;
receive data describing a first current failure of the first computer asset and a second current failure of a second computing asset;
receive hardware availability data describing a first unit of computer hardware;
determine that the computer asset VaR for the first computer asset is greater than a computer asset VaR for the second computer asset; and
responsive to the determining that the first computer asset VaR for the first computer asset is greater than the second computer asset VaR for the second computer asset send an allocation instruction indicating that the first unit of computer hardware is to be assigned to the first computer asset to correct the first current failure of the first computer asset by repairing the first computer asset.

11. The system of claim 10, wherein the system is further programmed to:
receive a plurality of failure logs including data describing the plurality of failure events of the first computer asset; and
parse the plurality of failure logs to generate the failure data.

12. The system of claim 10, wherein the system is further programmed to determine a loss from the first failure of the first computer asset at least in part by receiving resource data describing at least one resource used to correct the first failure of the first computer asset.

13. The system of claim 10, wherein determining the computer asset VaR for the first computer asset at the confidence level comprises: from a plurality of time period losses including the first time period loss and the second time period loss, selecting the first computer asset VaR such that the confidence level of the plurality of time period losses are less than or equal to the first computer asset VaR.

14. The system of claim 10, wherein determining the computer asset VaR for the first computer asset at the confidence level comprises:
determine a first model parameter based at least in part on the first time period loss and the second time period loss;
execute a plurality of random trials based at least in part on the first model parameter, wherein a first trial of the plurality of random trials results in a first trial time period loss and a second trial of the plurality of random trials results in a second trial time period loss; and
from a plurality of trial time period losses including the first trial time period loss and the second trial time period loss, selecting the first computer asset VaR such that the confidence level of the plurality of trial time period losses are less than or equal to the first computer asset VaR.

15. The system of claim 10, wherein determining the computer asset VaR for the first computer asset at the confidence level comprises:
fitting a probability distribution to a plurality of time period losses from the first computer asset, the plurality of time period losses comprising the first time period loss and the second time period loss; and
selecting the first computer asset VaR based at least in part on the probability distribution.

16. The system of claim 15, wherein the probability distribution is a Pareto distribution.

17. The system of claim 10, wherein the first computer asset is a software asset and wherein the first unit of computer hardware is a server.

18. The system of claim 10, wherein the first computer asset is a data asset and where the first unit of computer hardware is a data storage device.

19. A method for managing computer assets, comprising:
selecting, by a computer device, failure data describing a plurality of failure events of a first computer asset over a plurality of time periods comprising a first time period and a second time period;
identifying, by the computer device and from the failure data, first failure data describing a first failure of the first computer asset occurring during a first time period of the plurality of time periods;
determining, by the computer device, a first time period loss describing losses due to failure of the first computer asset during the first time period, the first time period loss based at least in part on the first failure data;
determining, by the computer device, a second time period loss describing losses due to failure of the first computer asset during the second time period, wherein the second time period loss is zero;
determining, by the computer device, a value at risk (VaR) for the first computer asset at a confidence level, wherein determining the first computer asset VaR comprises determining a first loss level at which a confidence level percentage of the plurality of time periods had time period losses equal to or less than the first loss level, wherein the first loss level is the first computer asset VaR;
receiving, by the computer device, data describing a first current failure of the first computer asset and a second current failure of a second computing asset;
receiving, by the computer device, hardware availability data describing a first unit of computer hardware;
determining, by the computer device, that the computer asset VaR for the first computer asset is greater than a computer asset VaR for the second computer asset; and
responsive to the determining that the first computer asset VaR for the first computer asset is greater than the second computer asset VaR for the second computer asset, sending an allocation instruction indicating that the first unit of computer hardware is to be assigned to the first computer asset to correct the first current failure of the first computer asset by repairing the first computer asset.

20. The method of claim 19, wherein determining the computer asset VaR for the first computer asset at the confidence level comprises: from a plurality of time period losses including the first time period loss and the second time period loss, selecting the first computer asset VaR such that the confidence level of the plurality of time period losses are less than or equal to the first computer asset VaR.
